(19) United States
(12) Patent Application Publication
(10) Pub. No.: US 2014/0165142 A1
(43) Pub. Date: Jun. 12, 2014

(54) INTERACTIVE CLOUD COMMUNICATION SYSTEM

(71) Applicant: NATIONAL CHENG KUNG UNIVERSITY, Tainan City (TW)

(72) Inventors: Chiang LEE, Tainan City (TW); Chao-Hsien HSIEH, New Taipei City (TW); Nai-Ying KO, Kaohsiung City (TW)

(73) Assignee: NATIONAL CHENG KUNG UNIVERSITY, Tainan City (TW)

(21) Appl. No.: 13/751,945

(22) Filed: Jan. 28, 2013

(30) Foreign Application Priority Data
Dec. 12, 2012 (TW) 101146960

(51) Int. Cl. H04L 29/06

(52) U.S. Cl. CPC H04L 63/04
USPC 726/3

(57) ABSTRACT

An interactive cloud communication system includes at least a client end and a cloud. The client end includes a browser. The cloud includes a cloud server module and a server module connected to the cloud server module. The cloud server module includes a websocket authentication unit. When the client end connects to the cloud through the browser, the cloud server module performs an authentication mechanism to the client end by the websocket authentication unit for opening at least a transmission channel allowing information transmission between the client end and the cloud.

### CROSS REFERENCE TO RELATED APPLICATIONS

This Non-provisional application claims priority under 35 U.S.C. §119(a) on Patent Application No(s). 101146960 filed in Taiwan, Republic of China on Dec. 12, 2012, the entire contents of which are hereby incorporated by reference.

### BACKGROUND OF THE INVENTION

1. Field of Invention

The invention relates to a cloud communication system and, in particular, to an interactive cloud communication system.

2. Related Art

In general, data transmission is limited by the data storing space and the network bandwidth, and especially when the image processing or recognizing is dealt with, the whole efficiency must be further limited by the hardware equipment for the computation. Therefore, in the conventional client-server architecture, the processing for the multimedia streaming application wherein the condition of multi-computer to multi-computer is involved seems more difficult.

Besides, presently the transmission on the internet of multimedia information including audio and video information is conducted in conformity with the real-time transport protocol (RTP), which is a network transmission protocol usually applied to the streaming media technology and becomes the mainstream of the media data transmission nowadays. However, in the application of RTP, the server end needs to be configured a large-size software for the operation, and that means a streaming server is required. Furthermore, in this case, the data lost during the transmission will not be recovered. In addition, in the application of RTP, the system will be hindered due to the problem of the fire wall or network address translation (NAT). Moreover, the most important issue in this case is that the RTP application can not provide interactive effect so as to be placed at a disadvantage in the future media architecture.

Therefore, it is an important subject to provide a cloud communication system that can ensure the data completeness during the transmission and the unhindered system operation, and also provide interactive effect, instead of being configured with a streaming server.

### SUMMARY OF THE INVENTION

In view of the foregoing subject, an objective of the invention is to provide a cloud communication system that can ensure the data completeness during the transmission and the unhindered system operation, and also provide interactive effect, instead of being configured with a streaming server.

To achieve the above objective, an interactive cloud communication system according to the invention comprises at least a client end and a cloud. The client end has a browser. The cloud includes a server module and a cloud server module connected to the server module and having a websocket authentication unit. When the client end is connected to the cloud through the browser, the cloud server module performs an authentication mechanism to the client end through the websocket authentication unit for forming at least a transmission channel allowing information transmission between the client end and the cloud.

In one embodiment, the cloud server module includes a cloud server or a plurality of cloud servers.

In one embodiment, at least two of the client ends use the same transmission channel.

In one embodiment, the interactive cloud communication system further comprises a resource end connected to the cloud server module. The cloud server module ascertains whether to make the resource end perform information processing according to a request of the client end. The information processing includes computing, storing, or their combination.

In one embodiment, the resource end includes a cloud server and at least a server, and the cloud server is connected to the server and cloud server module.

In one embodiment, the cloud server module makes the server module perform information processing according to a request of the client. The information processing includes computing, storing, or their combination.

In one embodiment, the cloud server module includes a plurality of cloud servers, and the client end communicates with the cloud servers through the different transmission channels, respectively.

In one embodiment, the server module includes a web server, a file server, a cluster server, a database server, a storage server, a mail server, a printer server, an application program server, an FTP server, or their any combination.

As mentioned above, the interactive cloud communication system according to the invention uses the websocket technology, which is a network technology providing full-duplex communication between a browser and a server. In the websocket technology, the browser and the server just need to do a handshake operation to form a rapid channel therebetween for the data transmission in the form of webpage. Thereby, the usability of the whole system can be enhanced and also the interactive effect is achieved.

Besides, because the interactive cloud communication system according to the invention doesn't use the real-time transport protocol (RTP), the streaming server needn't be disposed, the data completeness can be ensured, and the system operation will be unhindered.

Moreover, because the cloud communication is also applied to the invention, the cloud server module can appoint objects for the load balance so that the whole efficiency and performance can be enhanced. Accordingly, in the condition of multi-client to multi-server, the bandwidth in the invention still can be kept sufficient. In other words, taking advantage of expansibility of the cloud architecture, the invention can be applied to the situations of less bandwidth, insufficient hardware equipment, and limited data storing space.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of an interactive cloud communication system according to a preferred embodiment of the invention;

FIG. 2 is a schematic diagram of another interactive cloud communication system according to a preferred embodiment of the invention;

FIG. 3 is a schematic diagram showing a practical application of an interactive cloud communication system according to a preferred embodiment of the invention; and

FIG. 4 is a schematic diagram showing another practical application of an interactive cloud communication system according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

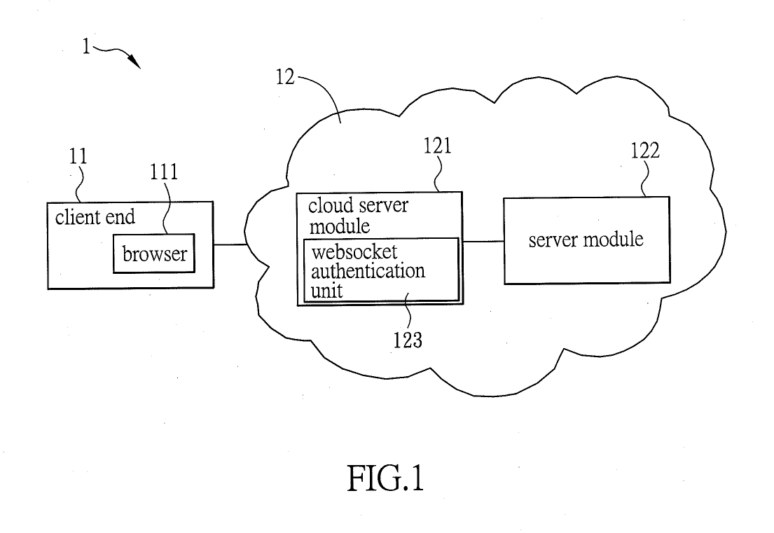

FIG. 1 is a schematic diagram of an interactive cloud communication system 1 according to a preferred embodiment of the invention. The interactive cloud communication system 1 includes at least a client end 11 and a cloud 12. Herein, one client end 11 is instanced in this embodiment.

The client end 11 includes a browser 111. The client end 11 can be embodied by many ways, such as by a computer, a cell phone, or other electronic devices having computing ability. The client end can connect to the webpage of a server through the browser 111 for transmitting information.

The cloud 12 includes a cloud server module 121 and a server module 122 connected to the cloud server module 121. The cloud sever module 121 includes a websocket authentication unit 123. Briefly, the websocket technology is a network technology providing full-duplex communication between a browser and a server. In the websocket technology, the browser and the server just need to do a handshake operation to form a rapid channel therebetween for the data transmission in the form of webpage. Thereby, the whole usability can be enhanced with an interactive effect. The cloud server module 121 and the server module 122 each can be embodied by many ways, which are not limited in the invention, such as by a computer, a server, or other electronic devices having computing ability, or their any combination. The cloud server module 121 can include a cloud server or a plurality of cloud servers. The cloud server module 121 is mainly responsible for the interior resource assignation, and the server module 122 can take charge of the information processing (computing, storing, etc.).

When the client end 11 is connected to the cloud 12 through the browser 111, the cloud server module 121 performs an authentication mechanism to the client end 11 by the websocket authentication unit 123 for opening at least a transmission channel allowing the information transmission between the client end 11 and the cloud 12. After starting the communication, the cloud server module 121 can make the server module 122 perform information processing according to a request of the client end 11. The information processing here can include, for example, computing, storing, or their combination. In this embodiment, the server module 122 is not limited in type, which can include, for example, a web server, a file server, a cluster server, a database server, a storage server, a mail server, a printer server, an application program server, an FTP server, or their any combination. The cloud server module 121 can make different servers of the server module 122 perform information processing according to different requests from the client end 11 or the cloud server module 121.

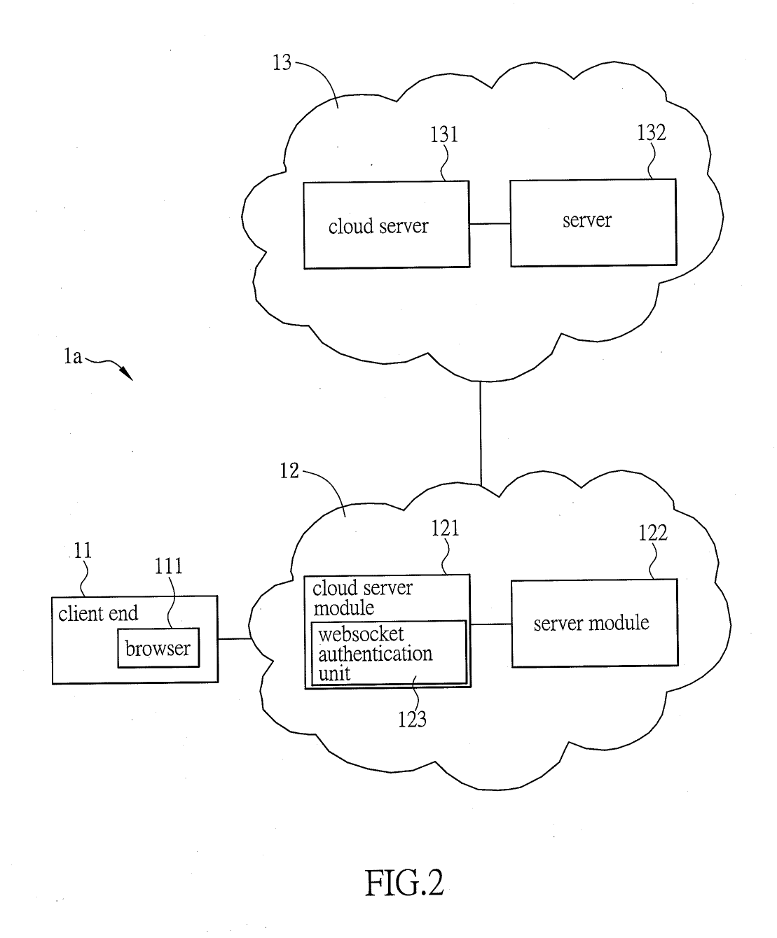

FIG. 2 is a schematic diagram of another interactive cloud communication system 1a according to a preferred embodiment of the invention. Compared with the interactive cloud communication system 1, the interactive cloud communication cloud 1a further includes a resource end 13 which is connected to the cloud server module 121, and the cloud server module 121 can ascertain whether to make the resource end 13 perform information processing, according to a request of the client end 11. In other words, the cloud server module 121 not only can make the server module 122 perform information processing, but also can make the resource end 13 perform information processing, so that the load balance of the whole system can be achieved for enhancing the processing efficiency. Therefore in this embodiment, the cloud server module 121 has a decision-making mechanism to ascertain the information processing is performed by at least one of the server module 122 and the resource end 13. The information processing includes, for example, computing, storing, or their combination. Herein, the resource end 13 is also instanced as a cloud including a cloud server 131 and at least a server 132 for example. The cloud server 131 is connected to the server 132 and the cloud server module 121. The cloud server 131 is mainly responsible for the interior resource assignation of the resource end 13, and the server 132 can take charge of the information processing (computing, storing, etc.).

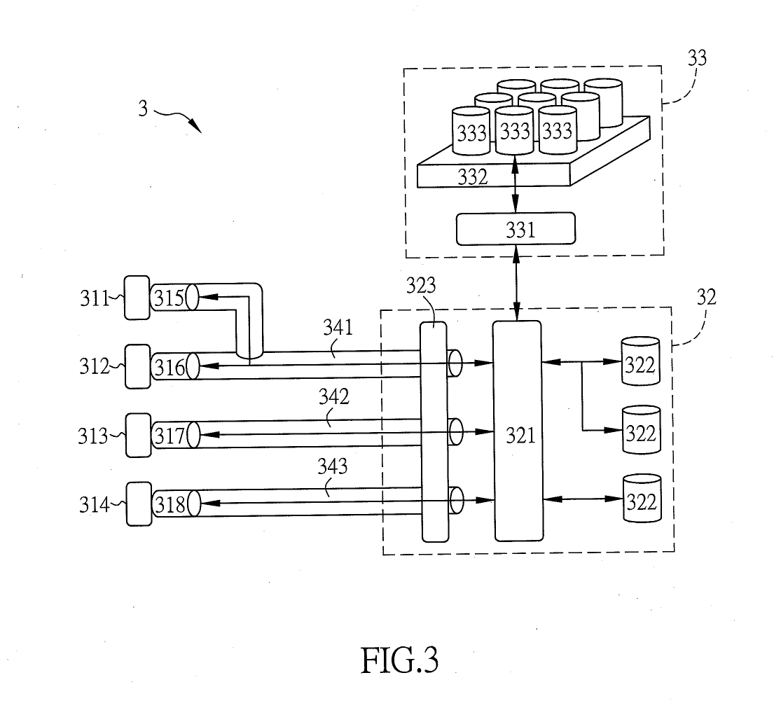

FIG. 3 is a schematic diagram showing a practical application of an interactive cloud communication system according to a preferred embodiment of the invention. The interactive cloud communication system 3 of this practical application shows the conditions of a client to a server and multi-client to a server.

As shown in FIG. 3, the interactive cloud communication system 3 includes a plurality of client ends, and four client ends are instanced here. The client ends have browsers 311˜314 respectively for browsing webpages. Besides, the client ends have their respective data storing spaces 315˜318 for storing data or information. Herein, the data storing spaces 315˜318 are instanced as temporary spaces, but however, the invention is not limited thereto.

In this practical application, the cloud 32 is a private cloud for example, which can provide software as a service (SaaS) and platform as a service (PaaS). In FIG. 3, the cloud 32 includes a cloud server 321 and three servers 322. The cloud server 321 is connected to the servers 322, and can appoint the required server 322 to perform information processing according to the requirements. The cloud server 321 can take charge of resource assignation and adjustment (including the automatic extension of TCP webpages), appointed objects, specific computing, etc. The servers 322 can perform information processing such as computing, storing, etc. When the client ends are connected to the cloud 32 through the browsers 311˜314, the cloud server 321 performs authentication mechanism to the client ends through a websocket authentication unit 323 for forming transmission channels 314˜343 allowing the information transmission respectively between the client ends and the cloud 32. In this practical application, at least two of the client ends can use the same transmission channel. For example in FIG. 3, the client ends having the browsers 311 and 312 use the same transmission channel 341.

Besides, the interactive cloud communication system 3 also includes a resource end 33, which is a cloud of infrastructure as a service (IaaS) for example. The resource end 33 includes a cloud server 331, a server platform 332 and a plurality of servers 333. The cloud server 331 takes charge of the affairs of interior resource assignation, and appoints the required server 333 through the server platform 332 to perform information processing, such as computing, storing, etc.

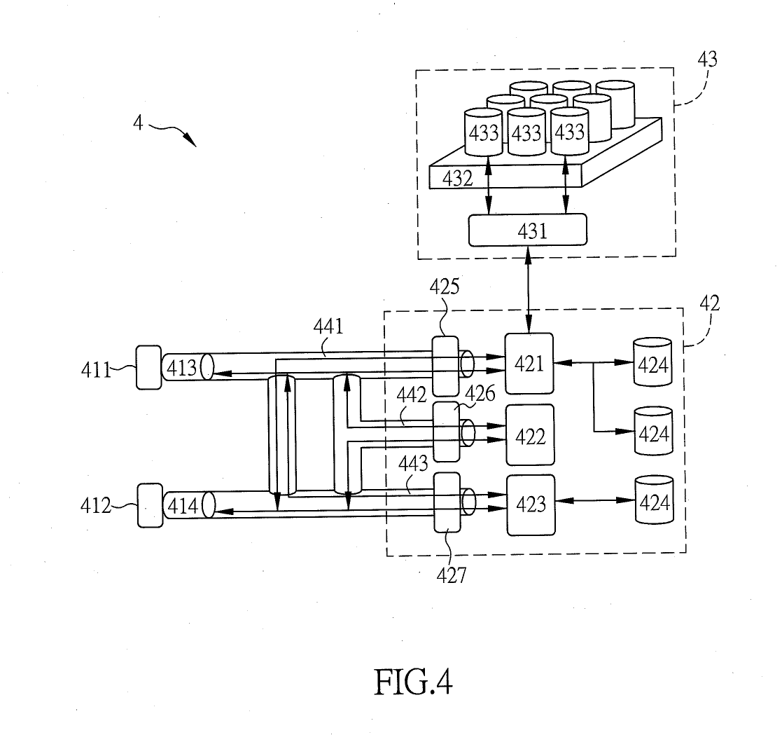

FIG. 4 is a schematic diagram showing another practical application of an interactive cloud communication system according to a preferred embodiment of the invention. The interactive cloud communication system 4 of this practical application shows the conditions of a client to multi-server and multi-client to multi-server.

As shown in FIG. 4, the interactive cloud communication system 4 includes a plurality of client ends, and two client ends are instanced here. The client ends have browsers 411 and 412 respectively for browsing webpages. Besides, the client ends have their respective data storing spaces 413 and 414 for storing data or information.

In this practical application, the cloud 42 is a private cloud for example, which can provide software as a service (SaaS) and platform as a service (PaaS). In FIG. 4, the cloud 42 includes three cloud servers 421˜423 and three servers 424. The cloud server 421 is connected to two of the servers 424, and can appoint any of the servers 424 to perform information processing according to the requirements. The cloud server 423 is connected to the other server 424. The cloud servers 421˜423 can take charge of resource assignation and adjustment (including the automatic extension of TCP webpages), appointed objects, specific computing, etc. The servers 424 can perform information processing such as computing, storing, etc. When the client ends are connected to the cloud 42 through the browsers 411 and 412, the cloud servers 421˜423 respectively perform authentication mechanisms to the client ends through the websocket authentication units 425˜427 thereof for forming transmission channels 441˜443 allowing the information transmission respectively between the client ends and the cloud 42. In this practical application, any of the client ends can use different transmission channels to communicate with the corresponding cloud servers. For example in FIG. 4, any of the client ends can use the transmission channels 441˜443.

Besides, the interactive cloud communication system 4 also includes a resource end 43, which is a cloud of infrastructure as a service (IaaS) for example. The resource end 43 includes a cloud server 431, a server platform 432 and a plurality of servers 433. The cloud server 431 takes charge of the affairs of interior resource assignation, and appoints the required server 433 through the server platform 432 to perform information processing, such as computing, storing, etc.

In summary, the interactive cloud communication system according to the invention uses the websocket technology, which is a network technology providing full-duplex communication between a browser and a server. In the websocket technology, the browser and the server just need to do a handshake operation to form a rapid channel therebetween for the data transmission in the form of webpage. Thereby, the usability of the whole system can be enhanced and also the interactive effect is achieved.

Besides, because the interactive cloud communication system according to the invention doesn't use the real-time transport protocol (RTP), the streaming server needn't be disposed, the data completeness can be ensured, and the system operation will be unhindered.

Moreover, because the cloud communication is also applied to the invention, the cloud server module can appoint objects for the load balance so that the whole efficiency and performance can be enhanced. Accordingly, in the condition of multi-client to multi-server, the bandwidth in the invention still can be kept sufficient. In other words, taking advantage of expansibility of the cloud architecture, the invention can be applied to the situations of less bandwidth, insufficient hardware equipment, and limited data storing space.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An interactive cloud communication system, comprising:
at least a client end having a browser; and
a cloud including a server module and a cloud server module connected to the server module and having a websocket authentication unit,
wherein when the client end is connected to the cloud through the browser, the cloud server module performs an authentication mechanism to the client end through the websocket authentication unit for forming at least a transmission channel allowing information transmission between the client end and the cloud.

2. The interactive cloud communication system as recited in claim 1, wherein the cloud server module includes a cloud server or a plurality of cloud servers.

3. The interactive cloud communication system as recited in claim 1, wherein at least two of the client ends use the same transmission channel.

4. The interactive cloud communication system as recited in claim 1, further comprising:
a resource end connected to the cloud server module, wherein the cloud server module ascertains whether to make the resource end perform information processing according to a request of the client end.

5. The interactive cloud communication system as recited in claim 4, wherein the information processing includes computing, storing, or their combination.

6. The interactive cloud communication system as recited in claim 4, wherein the resource end includes a cloud server and at least a server, and the cloud server is connected to the server and cloud server module.

7. The interactive cloud communication system as recited in claim 1, wherein the cloud server module makes the server module perform information processing according to a request of the client.

8. The interactive cloud communication system as recited in claim 7, wherein the information processing includes computing, storing, or their combination.

9. The interactive cloud communication system as recited in claim 1, wherein the cloud server module includes a plurality of cloud servers, and the client end communicates with the cloud servers through the different transmission channels, respectively.

10. The interactive cloud communication system as recited in claim 1, wherein the server module includes a web server, a file server, a cluster server, a database server, a storage server, a mail server, a printer server, an application program server, an FTP server, or their any combination.
